(19) United States
(12) Patent Application Publication
(10) Pub. No.: US 2023/0132727 A1
(43) Pub. Date: May 4, 2023

(54) LASER DESORPTION/IONIZATION MASS SPECTROMETER AND LASER POWER ADJUSTMENT METHOD

(71) Applicant: SHIMADZU CORPORATION, Kyoto-shi, Kyoto (JP)

(72) Inventors: Akihito KORENAGA, Kyoto-shi (JP); Ritsuko YODA, Kyoto-shi (JP); Tatsuki OKUBO, Kyoto-shi (JP); Tomonori OSHIKAWA, Kyoto-shi (JP); Yuko KOBAYASHI, Kyoto-shi (JP); Yoshiki TAINAKA, Kyoto-shi (JP); Kohei SUZUKI, Kyoto-shi (JP)

(73) Assignee: SHIMADZU CORPORATION, Kyoto-shi, Kyoto (JP)

(21) Appl. No.: 17/918,648

(22) PCT Filed: Nov. 26, 2020
(86) PCT No.: PCT/JP2020/044107

§ 371 Date: Oct. 13, 2022

(30) Foreign Application Priority Data
Apr. 20, 2020 (JP) 2020-074725

(51) Int. Cl. H01J 49/16; H01J 49/00; H01J 49/04

(52) U.S. Cl. CPC H01J 49/164; H01J 49/0036; H01J 49/0418

(57) ABSTRACT

One mode of the present invention provides a laser power adjustment method for ionization in a laser desorption/ionization mass spectrometer, the laser power adjustment method including: a measurement step (S1) in which intensity information on ions derived from a specific component in a specimen are acquired while changing laser power in n stages (n is 3 or more) for the identical specimen; and a processing step (S2, S6, and S7) in which a slope of a straight line connecting two adjacent plot points on a laser power axis is calculated in a two-axis graph in which a relationship between n ionic intensities obtained by the measurement step or a signal value, which is an SN ratio obtained from the ionic intensities, and laser power is plotted; an index value reflecting a ratio between a forward slope value, which is a slope of a straight line on a front side of the plot point, and a backward slope value, which is a slope of a straight line on a rear side, is obtained for each plot point; and appropriate laser power is selected using the index value.

### TECHNICAL FIELD

The present invention relates to a laser desorption/ionization mass spectrometer equipped with an ion source configured to ionize a compound in a specimen by irradiating the specimen with laser light, such as a matrix assisted laser desorption/ionization (MALDI) method, and an adjustment method of laser power in the mass spectrometer.

### BACKGROUND ART

In a mass spectrometer equipped with a MALDI ion source (hereinafter, referred to as “MALDI mass spectrometer”), by irradiating, with laser light for a short time, a sample prepared by mixing an inspection target specimen with an ionization aid called matrix, a specimen component in the sample is ionized while vaporizing it. The generated ions derived from the specimen component are introduced into a time-of-flight mass separator or an ion trap mass separator, and the ions are separated and detected according to a mass-to-charge ratio (strictly speaking, it is “m/z” in italics, but it is written as “mass-to-charge ratio” or “m/z” according to common usage).

In addition to the MALDI method, some methods for ionizing an analysis target object in a specimen by irradiating the specimen with laser light, such as the laser desorption/ionization (LDI) method and the surface assisted laser desorption/ionization (SALDI) method, are known.

The quality of the mass spectrum obtained in the MALDI mass spectrometer depends on various factors such as the component concentration of the specimen, the type of matrix used, the state of the laser light source for ionization, and the state of the ion detector. The intensity (laser power) of laser light with which the specimen is irradiated is one of factors that greatly affect the quality of the mass spectrum, and when the laser power is less than a threshold value of ionization in a specimen molecule, the specimen molecule is not ionized. On the other hand, when the laser power is excessive, thermal decomposition of specimen molecules and deterioration of mass resolution may occur (see Non Patent Literature 1 and the like).

Suitable laser power for efficiently ionizing specimen molecules also depends on the type of matrix. For example, 2,5-dihydroxybenzoic acid (DHB), which is a matrix frequently used in the MALDI method, generally requires higher laser power than α-cyano-4 hydroxycinnamic acid (CHCA) for proper ionization.

Thus, the optimum value of laser power depends on various conditions including the type of matrix to be used. Therefore, in an analysis using the MALDI mass spectrometer, usually, prior to analysis of a target specimen, a preliminary analysis is performed on a specimen prepared using the same type of matrix as that used for the analysis, and an appropriate laser power value is determined on the basis of the result. Such laser power adjustment is generally performed manually while the operator visually monitors the mass spectrum shown on the display screen.

### CITATION LIST

### Non Patent Literature

Non Patent Literature 1: Yutaka Takahashi, and one other, “Organic Mass Spectrometry”. The Japan Society for Analytical Chemistry, Bunseki, No. 7, 2007, p. 328-335 ([online], [searched on Jan. 29, 2020], Internet <:URL: https://www.jsac.or.jp/bunseki/pdf/bunseki2007/200707nyumon.PDF>)

### SUMMARY OF INVENTION

### Technical Problem

However, in the manual laser power adjustment as described above, the setting value of the laser power depends on the subjectivity of the operator. Therefore, the selected value vary depending on the operator, and as a result, there is a possibility that the mass spectrum obtained for the target specimen differs depending on the operator. Usually, analysis conditions such as the type of a matrix are different among batches of measurements, and thus, it is necessary to perform adjustment work of laser power for each batch of measurements. Therefore, when the number of measurement batches is large, the adjustment work by the operator is considerably complicated, which leads to an increase in human cost and a decrease in measurement efficiency.

The present invention has been made to solve such problems, and an object of the present invention is to provide a laser desorption/ionization mass spectrometer and a laser power adjustment method capable of automatically and objectively determining appropriate laser power capable of acquiring a good mass spectrum.

### Solution to Problem

One mode of a laser desorption/ionization mass spectrometer according to the present invention, which has been made to solve the above problems, provides a laser desorption/ionization mass spectrometer including:

an ion source configured to ionize a component in a specimen by irradiating the specimen with laser light;

a mass spectrometry unit configured to perform mass spectrometry of ions generated by the ion source;

an analysis control unit configured to control each of the ion source and the mass spectrometry unit so as to acquire signal intensities of ions derived from a specific component in a specimen while changing laser power of the laser light in n stages (n is an is integer of 3 or more) for an identical specimen; and

a processing unit configured to: calculate a slope of a straight line connecting two adjacent plot points in a laser power axis direction in a two-axis graph in which a relationship between n signal intensities obtained under control of the analysis control unit signal value, which is an SN ratio obtained from the signal intensities, and laser power is plotted; obtain, for each plot point, an index value reflecting a ratio between a forward slope value, which is a slope of a straight line on a front side of the plot point, and a backward slope value, which is a slope of a straight line on a rear side; and select an appropriate laser power using the index values.

One mode of a laser power adjustment method according to the present invention is a laser power adjustment method for ionization in a laser desorption/ionization mass spectrometer of the above mode, the laser power adjustment method including:

a measurement step in which signal intensities on ions derived from a specific component in a specimen are acquired while changing laser power in n stages (n is an integer of 3 or more) for an identical specimen; and

a processing step in which: a slope of a straight line connecting two adjacent plot points in a laser power axis direction is calculated in a two-axis graph in which a relationship between n signal intensities obtained in the measurement step or a signal value, which is an SN ratio obtained from the signal intensities, and laser power is plotted; an index value reflecting a ratio between a forward slope value, which is a slope of a straight line on a front side of the plot point, and a backward slope value, which is a slope of a straight line on a rear side, is obtained for each plot point; and appropriate laser power is selected using the index values.

### Advantageous Effects of Invention

The “laser desorption/ionization” method includes the above-described MALDI, LDI, and SALDI, and also includes all ionization methods of ionizing components in a specimen by irradiating the specimen with laser light.

In the laser desorption/ionization mass spectrometer of the above mode and the laser power adjustment method of the above mode according to the present invention, on the basis of an actual analysis result for a specimen, appropriate laser power capable of performing highly sensitive or highly accurate analysis is determined by an objective standard without relying on judgement by a human such as an operator. Therefore, according to the device and the method of the above mode according to the present invention, the laser power set at the time of analysis does not vary depending on the operator, and a highly reliable and good mass spectrum can be stably acquired. Since appropriate laser power can be determined substantially without manual intervention, human cost can be reduced and analysis efficiency can be improved. The device and the method of the above mode according to the present invention are also advantageous for automating analyses. Furthermore, in the device and the method of the above mode according to the present invention, since the procedure for determining appropriate laser power is close to that based on a general human judgment criterion, there is also an advantage that the operator may not feel strange about the determined laser power value, so that the determined laser power value is easily accepted.

### BRIEF DESCRIPTION OF DRAWINGS

FIG. 1 is a configuration diagram of a main part of a MALDI-TOFMS according to one embodiment of the present invention.

FIG. 2 is a flowchart showing a laser power adjustment procedure in the MALDI-TOFMS of the present embodiment.

FIG. 3 is a graph showing an example of a relationship between laser power and an SN ratio based on an actual measurement result.

FIG. 4 is a view showing index values based on a forward slope value and a backward slope value calculated from the graph shown in FIG. 3.

FIG. 5 is a graph showing another example of a relationship between laser power and an SN ratio based on an actual measurement result.

FIG. 6 is a view showing index values based on a forward slope value and a backward slope value calculated from the graph shown in FIG. 5.

FIG. 7 is a graph showing another example of a relationship between laser power and an SN ratio based on an actual measurement result.

FIG. 8 is a view showing index values based on a forward slope value and a backward slope value calculated from the graph shown in FIG. 7.

FIG. 9 is a view showing an example of a laser power determination method creation screen in the MALDI-TOFMS of the present embodiment.

FIG. 10 is an enlarged view of a partial display in FIG. 9.

FIG. 11 is a view showing an example of a laser power determination inspection execution screen in the MALDI-TOFMS of the present embodiment.

FIG. 12 is a flowchart showing an improvement example of a laser power adjustment procedure in the MALDI-TOFMS of the present embodiment.

FIG. 13 is a flowchart showing an improvement example of a laser power adjustment procedure in the MALDI-TOFMS of the present embodiment.

FIG. 14 is a graph showing an example of a relationship between laser power and an SN ratio based on an actual measurement result.

FIGS. 15A and 15B are views showing index values based on a forward slope value and a backward slope value calculated from the graph shown in FIG. 14, and respective numerical values obtained by the procedure of the improvement example.

FIG. 16 is a graph showing another example of a relationship between laser power and an SN ratio based on an actual measurement result.

FIGS. 17A and 17B are views showing index values based on a forward slope value and a backward slope value calculated from the graph shown in FIG. 16, and respective numerical values obtained by the procedure of the improvement example.

### DESCRIPTION OF EMBODIMENTS

Hereinafter, a matrix assisted laser desorption/ionization time-of-flight mass spectrometer (MALDI-TOFMS) that is one embodiment of a laser desorption/ionization mass spectrometer according to the present invention will be described with reference to the accompanying drawings.

[Configuration of MALDI-TOFMS of Present Embodiment]

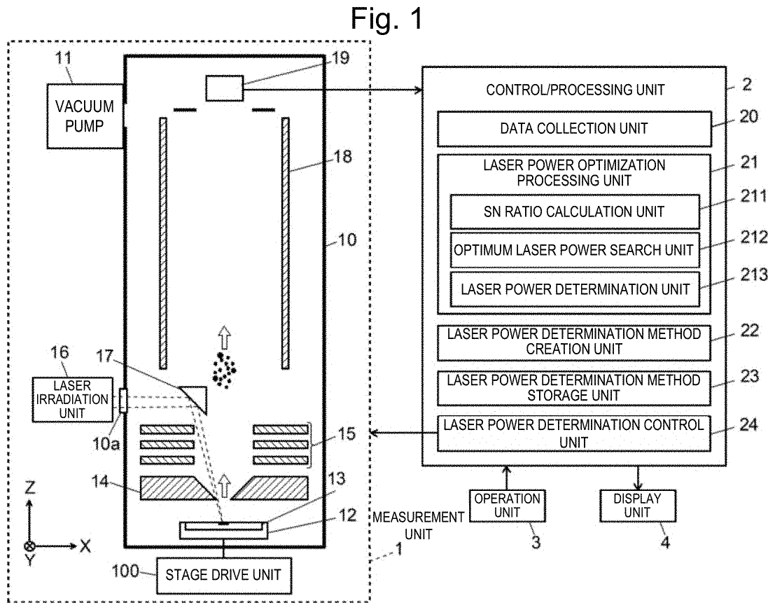

FIG. 1 is a schematic configuration diagram of the MALDI-TOFMS of the present embodiment. A measurement unit of this device is a combination of a MALDI ion source and a linear time-of-flight mass separator.

As shown in FIG. 1, the MALDI-TOFMS of the present embodiment includes a measurement unit 1, a control/processing unit 2, an operation unit 3, and a display unit 4. In the measurement unit 1, a specimen stage 12 retaining a sample plate 13, an extraction electrode 14, an acceleration electrode 15, a flight tube 18 forming a flight space inside of the flight tube 18, and an ion detector 19 are arranged inside a chamber 10 evacuated by a vacuum pump 11. A wall face of the chamber 10 is provided with a transparent window 10a, and a laser irradiation unit 16 is disposed outside the chamber 10 and a mirror 17 is disposed inside the chamber 10 with the window 10a interposed between the laser irradiation unit 16 and the mirror 17. The laser irradiation unit 16 and the mirror 17 constitute an ionization unit.

Three axes of X, Y, and Z orthogonal to one another are defined in the space for the sake of convenience in order to show the positional relationship among the units in the measurement unit 1 in an easy-to-understand manner. The specimen stage 12 is movable in two axial directions of an X axis and a Y axis by a stage drive unit 100 including a motor.

The control/processing unit 2 includes, as characteristic functional blocks, a data collection unit 20, a laser power optimization processing unit 21, a laser power determination method creation unit 22, a laser power determination method storage unit 23, a laser power determination control unit 24, and the like.

The laser power optimization processing unit 21 includes, as lower functional blocks, an SN ratio calculation unit 211, an optimum laser power search unit 212, and a laser power determination unit 213. The operation unit 3 and the display unit 4, which are user interfaces, are connected to the control/processing unit 2.

In general, the control/processing unit 2 mainly includes a computer such as a personal computer or a workstation, and the functional blocks can be embodied by the computer executing dedicated software (computer program) installed in the computer. In this case, the operation unit 3 is a keyboard or a pointing device attached to the computer, and the display unit 4 is a display monitor.

[Measurement Operation of MALDI-TOFMS of Present Embodiment]

A general measurement operation in the MALDI-TOFMS of the present embodiment is as follows.

A measurement target sample is formed on the sample plate 13, which is flat. The sample plate 13 is made of metal such as stainless steel, and an upper surface of the sample plate 13 is provided with wells having a circular shape in top view in M rows×N columns (both M and N are positive integers). A sample prepared by mixing the specimen and the matrix is formed inside each well. The preparation method for the sample is not particularly limited. The matrix is appropriately selected depending on the type of the specimen and the like.

The sample plate 13 in which a sample is formed in each well is placed on the specimen stage 12 as shown in FIG. 1. When the sample plate 13 is placed and the operator performs a predetermined operation from the operation unit 3, the inside of the chamber 10 is evacuated by the vacuum pump 11 under control of the control/processing unit 2, and measurements performed.

That is, the laser irradiation unit 16 emits laser light for a short time. The emitted laser light passes through the window 10a as indicated by a dotted line in FIG. 1, hits the mirror 17, is reflected downward, and with which one of the samples on the sample plate 13 is irradiated. As described above, the specimen stage 12 is movable in two axial directions of the X axis and the Y axis by the stage drive unit 100, and the irradiation position of the laser light is adjusted by the movement of the specimen stage 12.

Upon being irradiated with the laser light, specimen components in the sample are vaporized and ionized. The generated ions derived from the specimen are extracted substantially in the positive direction of the Z axis from the vicinity of the surface of the sample plate 13 by the action of an electric field formed by a direct-current voltage applied to the extraction electrode 14 from a power source unit (not illustrated). This ion reaches the acceleration electrode 15, and is applied with kinetic energy by the action of an acceleration electric field formed by the voltage applied from the power source unit to the acceleration electrode 15. Due to this, the ions are accelerated in the positive direction of the Z axis, and are introduced into a flight space with no electric field and no magnetic field inside the flight tube 18. While flying in this flight space, ions are separated according to the mass-to-charge ratio, and ions having different mass-to-charge ratios are shifted in time and reach the ion detector 19.

The ion detector 19 detects arriving ions, and generates and outputs a detection signal corresponding to the amount of the ions. The data collection unit 20 receives this detection signal, converts it into digital data, and creates a mass spectrum by converting the flight time corresponding to the obtained data into a mass-to-charge ratio. Usually, measurement is repeated a plurality of times while changing the irradiation position of the laser light little by little for the same sample. Then, the mass spectrum for one sample is created by integrating the mass spectrum data obtained in each of the plurality of times of measurement. This is because, in the MALDI method, in general, the amount of ions generated by one time of laser light irradiation is relatively small and the variation in the generation amount is relatively large, and sensitivity and reproducibility can be improved by performing data integration as described above.

[Example of Laser Power Adjustment Method]

When the measurement as described above is performed, it is necessary to appropriately set the intensity of the laser light with which the sample is irradiated according to the type of matrix to be used and measurement conditions such as a detector voltage (direct-current voltage applied to the ion detector 19). The MALDI-TOFMS of the present embodiment has a function of automatically determining the optimum value of laser power without depending on the subjectivity of the operator.

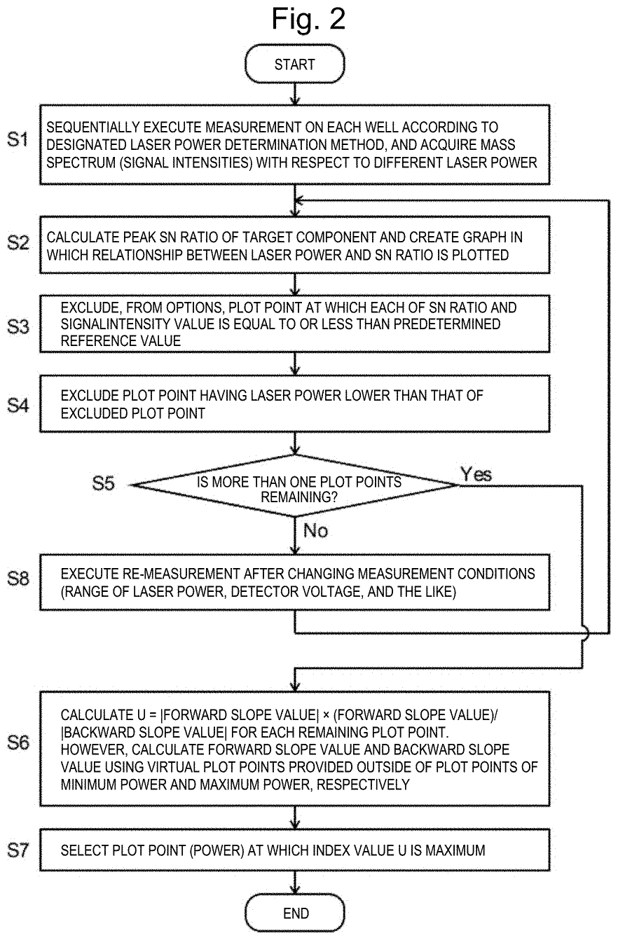

Next, this laser power adjustment method will be described with reference to FIG. 2. FIG. 2 is a flowchart showing a laser power adjustment procedure in the MALDI-TOFMS of the present embodiment.

In general, as laser power is gradually increased from a low level in the MALDI method (and other laser desorption/ionization methods), specimen components are ionized when the laser power reaches a certain level or more, and the signal intensity and the SN ratio increase with the increase in the laser power. When the laser power reaches a certain value, even if the laser power is farther increased, the SN ratio levels off or decreases due to an increase in the generation amount of decomposition products, noise, and the like. The signal intensity shows a similar tendency. The present inventor has focused on such a relationship between the laser power and the SN ratio (and signal intensity), and has found a method for determining the optimum value of the laser power from the shape of the graph indicating the relationship.

Specifically, the optimum value of the laser power can be found by the following procedure.

The operator prepares a sample using a specimen (standard specimen) containing an analysis target substance or a specific substance having a relatively close ionization efficiency to the analysis target substance, and a matrix used for analysis of the target specimen. As the sample, for example, n×L (n is an integer of 3 or more, and L is an integer of 1 or more) samples having the same concentration are prepared.

The laser power determination control unit 24 sequentially executes measurement on the n×L samples according to a laser power determination method (a type of data file in which measurement conditions are described) designated by the operator. That is, the laser power determination control unit 24 controls the measurement unit 1 so as to execute measurement under one laser power value for L samples while changing the laser power in n stages at equal power intervals. The data collection unit 20 acquires mass spectrum data in each measurement (step S1). Note that together with the measurement on the sample, the measurement on a calibrant described later is also performed, and mass calibration of the measurement result on the sample is performed using the measurement result of the calibrant.

Similarly to the general measurement, also at this time, the measurement for different positions under the same laser power value is repeatedly executed for each sample of the L samples, and the mass spectrum data obtained in each of the plurality of times of measurement is integrated.

However, it is for the purpose of avoiding the influence of sample disappearance by laser light irradiation to execute the measurement under the same laser power value on the L samples, or to execute the measurement under different laser power values on different samples, that is, to prepare n×L samples for n stages of laser power. Therefore, unless there is a possibility of being affected by disappearance of such a sample, for example, all measurements under n stages of laser power may be performed on one sample.

The laser power determination method is created in advance and stored in the laser power determination method storage unit 23, and this point will be described later.

When the measurement under the n stage of laser power in step S1 is finished, the SN ratio calculation unit 211 acquires, from the collected data, a signal intensity value of a peak observed at a predetermined mass-to-charge ratio for each laser power value, and calculates the SN ratio from the signal intensity value. This predetermined mass-to-charge ratio is a mass-to-charge ratio corresponding to the analysis target substance or the specific substance described above. One SN ratio value for each laser power, that is, n SN ratio values are obtained. Moreover, the SN ratio calculation unit 211 creates a graph in which n plot points indicating the relationship between the laser power value and the SN ratio value are positioned with the laser power on the horizontal axis and the SN ratio on the vertical axis (step S2).

Next, using the SN ratio value and the signal intensity value when the SN ratio value is calculated, the optimum laser power search unit 212 excludes a plot point that is obviously inappropriate. Specifically, the SN ratio value and the signal intensity value corresponding to each plot point are compared with a predetermined reference value, and a plot point where either or both of the SN ratio value and the signal intensity value are equal to or less than the reference value is excluded (step S3). This is processing for mainly excluding, from selection targets, laser power in which ionization is not substantially performed or ionization efficiency is significantly low, and the reference value can be appropriately decided. The user may be capable of appropriately setting the reference value.

If there is a plot point having a laser power value lower than the plot point excluded in step S3, the optimum laser power search unit 212 also excludes the plot point (step S4). After that, the optimum laser power search unit 212 determines whether or not a plurality of remaining plot points are present (step S5), and if a plurality of plot points are not present, the process proceeds from step S5 to step S8 described later.

If determining Yes in step S5, the optimum laser power search unit 212 calculates the slope of the straight line connecting two plot points adjacent in the horizontal axis (laser power axis) direction on the graph. Note that at this time, also using the plot points excluded in the processing of steps S3 and S4, the slopes of all the original n plot points are obtained.

The optimum laser power search unit 212 obtains a virtual plot point P₀ having a laser power lower than that of a plot point P₁ using the following equation with respect to the plot point P₁ having the lowest laser power among the original n plot points, and obtains the slope of the straight line between the plot point P₁ and the virtual plot point P₀.

(SN ratio of virtual plot point P₀)=(SN ratio of plot point P₁)−(Maximum value of SN ratio among original n plot points−minimum value of SN ratio among original n plot points)/(Interval of laser power)

(Laser power at virtual plot point P₀)=(Laser power at plot point P₁)−(Laser power interval)

Furthermore, with respect to a plot point Pₙ having the highest laser power among the original n plot points, the optimum laser power search unit 212 obtains a virtual plot point Pₙ₊₁ having the laser power higher than that of the plot point Pₙ by using the following equation, and obtains the slope of the straight line between the plot point Pₙ and the virtual plot point Pₙ₊₁.

(SN ratio of virtual plot point Pₙ₊₁)=(SN ratio of plot point Pₙ₊₁)|(Maximum value of SN ratio among original n plot points−minimum value of SN ratio among original n plot points)/(Interval of laser power)

(Laser power at virtual plot point P₀)=(Laser power at plot point Pₙ₊₁)+(Laser power interval)

Finally, the optimum laser power search unit 212 calculates an index value U using the following formula (1) for each plot point remaining after steps S3 and S4 (step S6).

U=|Forward slope value|×(Forward slope value)/|Backward slope value| (1)

Here, the “forward slope value” is the slope of a straight line connecting a plot point being focused and a plot point immediately before the plot point (laser power is lower by one stage), and the “backward slope value” is the slope of a straight line connecting a plot point being focused and a plot point immediately after the plot point (laser power is higher by one stage). Calculation of the index value U is unnecessary for the plot points excluded in steps S3 and S4.

The laser power determination unit 213 compares the index values U calculated for the plurality of plot points, and selects a laser power value corresponding to the plot point giving the maximum index value U as the optimum laser power (step S7).

On the other hand, if it is determined No in step S5, the laser power determination unit 213 judges that the laser power cannot be determined by the data obtained at that time. In response to this judgement, the laser power determination control unit 24 changes the measurement conditions (parameters) defined in the designated laser power determination method, for example, the range in which the laser power is changed and the voltage applied to the ion detector 19, and then controls the measurement unit 1 so as to execute re-measurement on the sample (step S8). Then, similarly to step S1, mass spectrum data is collected by re-measurement, and the above-described processing in and after step S2 is performed.

As described above, in the MALDI-TOFMS of the present embodiment, appropriate laser power can be automatically determined on the basis of an actual measurement result not relying on judgement of the operator (user). This makes it possible not only to save time and effort for determination of laser power but also to objectively determine the laser power without human subjectivity.

The above formula (1) is basically a formula for deciding the index value U based on the ratio between the forward slope value and the backward slope value, but here, the forward slope value is weighted by further multiplying the ratio by the forward slope value. That is, the index value is obtained by emphasizing on the forward slope value as compared with the backward slope value. The reason for this will be described later.

Note that instead of using the predetermined reference value to exclude the plot points in step S3, a coefficient of variation (CV) value obtained from each of the SN ratio value and the signal intensity value by actual measurement, that is, a value obtained by dividing the standard deviation by the mean value may be used.

[Laser Power Determination Method Creation Processing]

As described above, the laser power determination method used in the measurement for the laser power selection is created in advance and saved in the laser power determination method storage unit 23. Next, processing for laser power determination method creation in the MALDI-TOFMS of the present embodiment will be described.

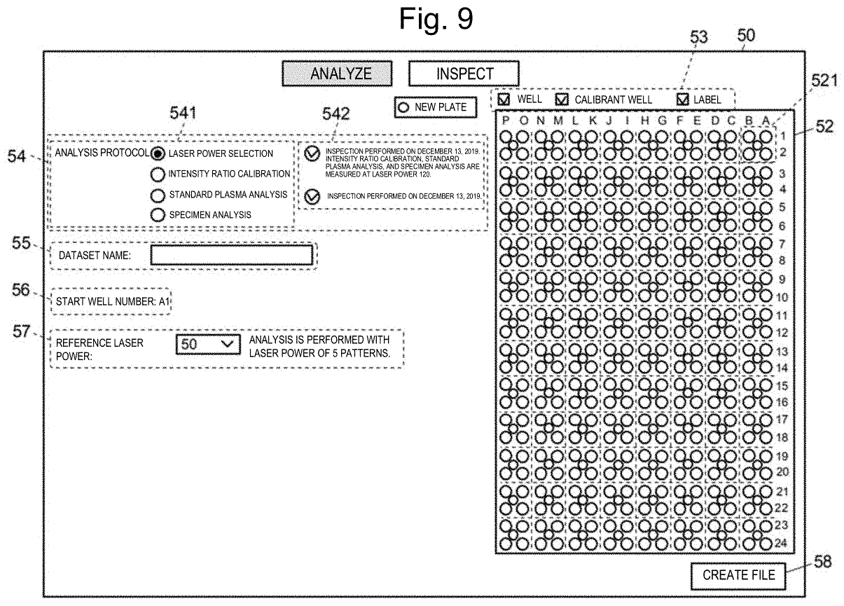

In response to a predetermined operation from the operation unit 3 by the operator, the laser power determination method creation unit 22 displays a laser power determination method creation screen 50 as shown in FIG. 9 on the display unit 4. This laser power determination method creation screen 50 is provided with an analysis protocol selection section 54, a dataset name input section 55, a start well number display section 56, a reference laser power value input section 57, and a sample plate schematic display section 52. The analysis protocol selection section 54 is provided with names of four types of analysis protocols, radio buttons 541 for selecting one of them, and an analysis protocol implementation information display section 542. The start well number display section 56 shows the well number (“A1” in this example) to be analyzed first in the selected analysis protocol. Note that this laser power determination method creation screen 50 is a screen in a state where the “laser power selection” protocol is selected, and when another analysis protocol is selected, a part of the display is changed.

The sample plate schematic display section 52 displays a simulated view of the sample plate used for analysis. As shown in FIG. 9, in the sample plate used here, sample wells in which samples for analysis are formed are arranged in 24 (=M) rows and 16 (=N) columns. With a total of 4 (=L) wells adjacent in the row direction and the column direction as a group, one calibrant well is disposed at the center of the group. Hereinafter, these four sample wells and one calibrant well are collectively referred to as well group 521. The calibrant well is a well in which a calibrant mainly for mass calibration is formed. In FIG. 9, the sample well is indicated by a relatively large circle, and the calibrant well is indicated by a relatively small circle.

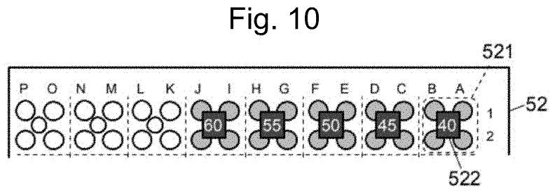

A display item selection section 53 is arranged on the sample plate schematic display section 52, and the display item selection section 53 is provided with check boxes for selecting whether or not to display a well, a calibrant well, and a label. When the operator marks the check boxes for the well and the calibrant well in the display item selection section 53, a circle indicating the position of each well is displayed in the sample plate schematic display section 52 as shown in FIG. 9. On the other hand, the label is a character display indicating a laser power value described later, and when the operator marks the check box for the label, as shown in FIG. 10, a laser power value 522 is displayed for the each well group 521.

The operator inputs an appropriate dataset name in the text box of the dataset name input section 55 on the laser power determination method creation screen 50. An appropriate reference laser power value is selected from a pull-down menu in the text box of the reference laser power value input section 57. In the device of the present embodiment, the laser power value is changed in 5 stages (that is, n=5) at 5 intervals, and the laser power value in the middle (third from the top) among the 5 stages is the reference laser power value. In the example shown in FIG. 9, since the reference laser power value is set to “50”, the laser power values at the 5 stages are “40”, “45”, “50”, “55”, and “60” at 5 intervals. Since the start well number is set to A1, as shown FIG. 10, labels indicating the laser power values “40”, “45”, “50”, “55”, and “60” are superimposed and displayed on the well group 521 including sample wells with well numbers A1, C1, E1, G1, and I1, respectively, in the sample plate schematic display section 52.

In the sample plate schematic display section 52 at this time, in each of the five well groups 521 used for the laser power determination processing, the sample well is displayed in a color (for example, yellow) indicating a well in which a sample (standard specimen) for laser power determination is formed, and the center calibrant well is displayed in a color (for example, purple) indicating a well in which a calibrant is formed.

Note that the label indicating the laser power value is superimposed and displayed on the well group 521 in the sample plate schematic display section 52 as described above only when the check box of the label is marked in the display item selection section 53, and it is possible to turn off the display of the label indicating the laser power value by removing this mark. Conversely, by removing the mark of the check box of the well or the calibrant well in the display item selection section 53, it is also possible to turn off the display of the circle indicating the sample well or the calibrant well in the sample plate schematic display section 52. This allows the display to be easily viewed depending on the preference of the operator. When the operator changes the reference laser power value using the reference laser power value input section 57, the laser power value set for each of the five well groups 521 is changed.

When the operator performs click operation on a file creation button 58 after setting the reference laser power value as described above, the laser power determination method creation unit 22, in response to this operation, creates the laser power determination method file based on the conditions such as the reference laser power value set at that time point. This laser power determination method file includes five patterns of methods for analyzing samples of corresponding well numbers under the five laser power values described above.

Note that although each well group 521 includes one calibrant well, different laser power values can be set for the sample well and the calibrant well in the same well group. Even in a case where the laser power values for the sample wells in each well group 521 are different, all the laser power values for the calibrant wells in each well group 521 can be made the same value. That is, the laser power value for the calibrant well can be decided on a screen different from the reference laser power value input section 57. This is to perform, on the same basis, mass calibration based on the analysis result for the sample formed in the sample well.

The laser power determination method file created by the laser power determination method creation unit 22 as described above is saved in the laser power determination method storage unit 23. The operator can create a plurality of laser power determination methods having different conditions from one another and save them in the laser power determination method storage unit 23.

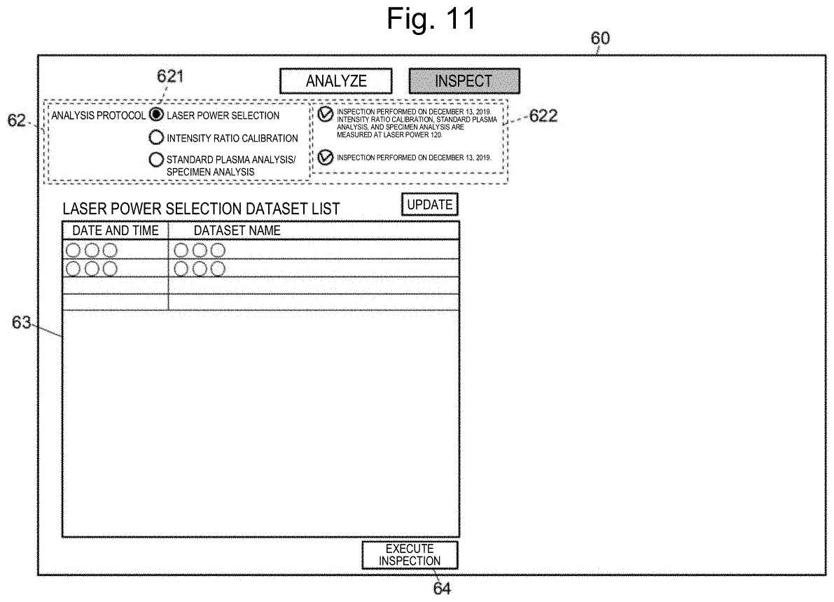

After creating the laser power determination method, the operator sets, on the specimen stage 12, a sample plate 13 in which a standard specimen, a calibrant, and a target specimen are each prepared in an appropriate well. After that, when the operator performs a predetermined operation on the operation unit 3, the laser power determination control unit 24 displays a laser power determination inspection execution screen 60 as shown in FIG. 11 on the display unit 4. On the laser power determination inspection execution screen 60, an analysis protocol selection section 62 same as the analysis protocol selection section 54 and a laser power selection dataset list 63 are arranged.

In the laser power selection dataset list 63, a list of the laser power determination method files saved in the laser power determination method storage unit 23 is displayed. The operator selects a laser power determination method file to be used for analysis, and then performs click operation on an inspection execution button 64. By this operation, the laser power determination control unit 24 performs analysis according to the selected laser power determination method file in the procedure as described above, and determines appropriate laser power on the basis of the analysis result. The value of the determined laser power is displayed in an analysis protocol implementation information display section 622 of the analysis protocol selection section 62. In the example of FIG. 11, the value of “120” on the display of “measured with laser power 120” is changed to the value determined in the above-described procedure.

As described above, the MALDI-TOFMS of the present embodiment can automatically determine the laser power appropriate for analyzing the target sample.

### EXPERIMENT EXAMPLE

Next, an experiment example of laser power adjustment according to the above-described procedure will be described. Specific measurement conditions and the like are as follows.

(1) Measurement Conditions

Specimen: Peptide mixed specimen dissolved in 70% acetonitrile solution

Matrix: CHCA dissolved in 70% acetonitrile solution containing 0.05% TFA (trifluoroacetic acid)

Mass spectrometer: AXIMA Performance (manufactured by Shimadzu Corporation)

(2) Conditions of Laser Power Adjustment

Laser power interval and number of change stages: 5 stages at 5 intervals (n=5)

Measurement mode under identical laser power: Raster scan mode

When the laser power was adjusted, the intensity of typical peptide-derived ions in the peptide mixed specimen was used.

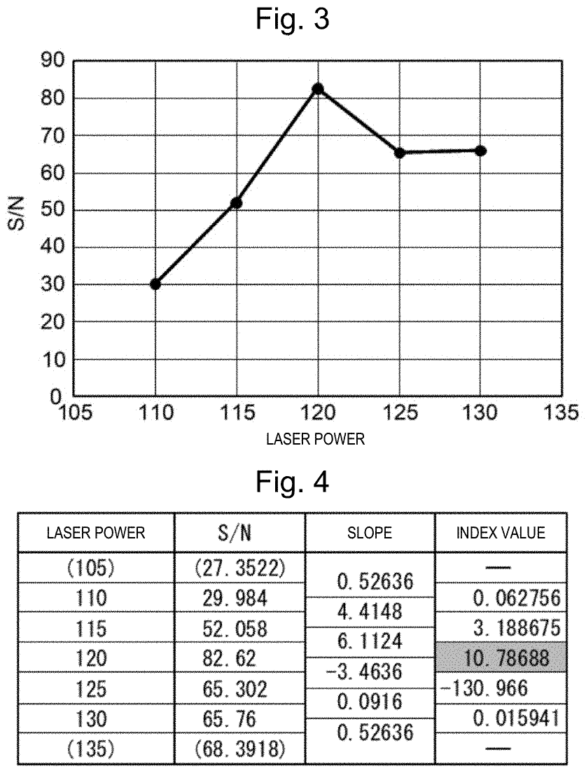

FIGS. 3, 5, and 7 are views showing relationships between laser power and an SN ratio based on actual measurement values by experiment examples different from one another. FIGS. 4, 6, and 8 are views showing index values based on the forward slope value and the backward slope value calculated from the graphs shown in FIGS. 3, 5, and 7, respectively.

In the first experiment example, the laser power and the SN ratio have the relationship shown in FIG. 3, and the slope of the straight line between two adjacent plot points and the index value are calculated from this result as shown in FIG. 4. In FIG. 4, the laser power “105” and “135” are the virtual plot points described above. When the relationship between the laser power and the SN ratio is a graph as shown in FIG. 3, the operator is considered to select the laser power “120” in general. As shown in FIG. 4, the laser power of the plot point giving the maximum index value is “120”, and it is found that selection consistent with general operator's subjectivity is performed in automatic selection based on the index value.

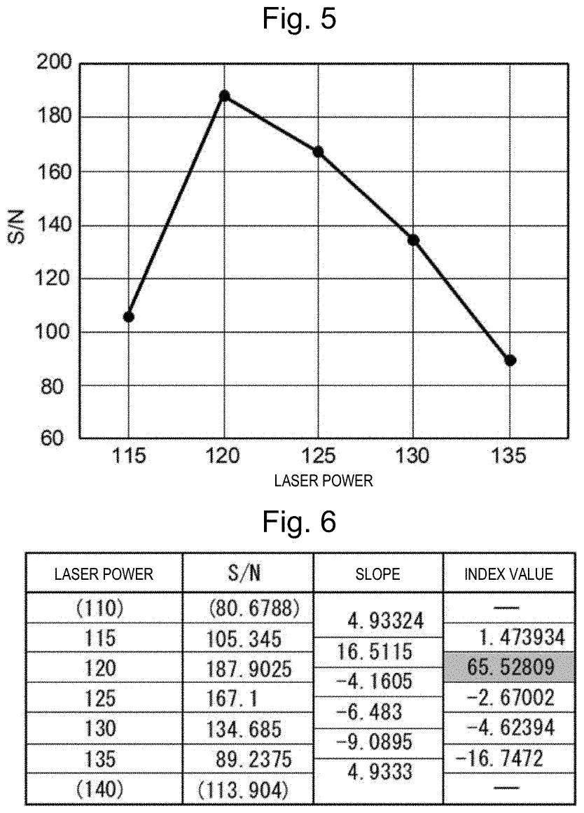

In the second experiment example, the laser power and the SN ratio have the relationship shown in FIG. 5, and the slope of the straight line between two adjacent plot points and the index value are calculated from this result as shown in FIG. 6. When the relationship between the laser power and the SN ratio is a graph as shown in FIG. 5, the operator is considered to select the laser power “120” in general. As shown in FIG. 6, the laser power of the plot point giving the maximum index value is “120”, and it is found that although the shape of the graph is different from that of the first experiment example, automatic selection consistent with general operator's subjectivity is performed also in this example.

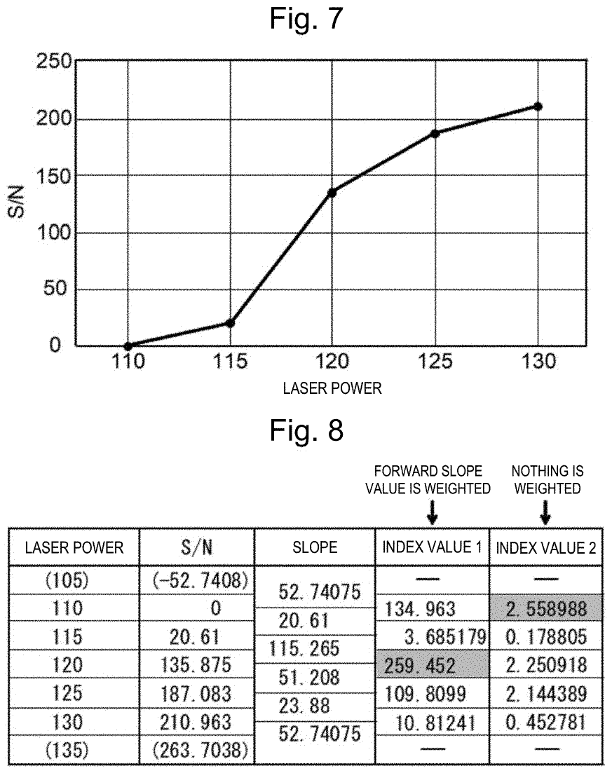

In the third experiment example, the laser power and the SN ratio have the relationship shown in FIG. 7, and the slope of the straight line between two adjacent plot points and the index value are calculated from this result as shown in FIG. 8. In FIG. 8, an index value 1 is an index value calculated by the above formula (1), and an index value 2 is an index value based on simply a ratio between the forward slope value and the backward slope value. That is, the index value 2 is a result with the forward slope value not weighted. In this example, as shown in FIG. 7, the SN ratio consistently increases with the increase in the laser power. However, it is estimated that the degree of increase in the SN ratio is the maximum at the laser power “115”→“120”, and the increase in the SN ratio tends to be saturated when the laser power exceeds “120”.

As shown in FIG. 7, when the degree of increase in the SN ratio tends to be saturated, there is a possibility that saturation has actually occurred in the detector 9. In such a situation, there is also a possibility that the mass resolution has lowered. Therefore, in a case where the operator selects laser power on the basis of such a graph, it is general to avoid laser power that has a possibility that saturation has occurred and select laser power that has an SN ratio as high as possible. Therefore, there is a high possibility that the laser power “120” is selected.

As shown in FIG. 8, when laser power is selected using the ratio between the forward slope value and the backward slope value simply as an index value, a laser power having a small component of the backward slope value (close to 0) is selected. However, such a state is likely to occur when the SN ratio levels off or when ionization is not sufficient, and erroneous selection is performed. In the example of FIG. 8, when the laser power is selected using the index value 2, “110” is selected, but this is obviously wrong. On the other hand, when the index value 1 weighted to the forward slope value is used, the laser power “120” is selected. That is, even when the relationship between the laser power and the SN ratio becomes as shown in the graph of FIG. 7, it is possible to select appropriate laser power according to human judgement by obtaining the index value by the above formula (1).

[Modification of Laser Power Adjustment Method]

Next, a modification obtained by improving the laser power adjustment method based on the above procedure will be described.

In the laser power adjustment method whose flowchart is shown in FIG. 2, it is assumed that the SN ratio does not sharply decrease in a process of increasing the laser power, and under this assumption, even if a plot point accidentally satisfies the reference value due to a measurement error or the like at a stage where the laser power is lower than the optimum value, the processing of step S4 is performed so as not to select the laser power value corresponding to the plot point. However, in some cases, there is a possibility that the SN ratio greatly decreases against the assumption due to an increase in noise in the process of increasing the laser power, and the plot point no longer satisfies the reference value. In this case, the optimum laser power value is a value smaller than the laser power when the plot point does not satisfy the reference value, but since the plot point having the laser power smaller than that of the plot point not satisfying the reference value has been excluded by the processing in step S4, there is a case where the optimum laser power value has also been excluded and a need for re-measurement arises. In the determination of step S5, even if there are only two remaining plot points, one of them is selected, but there is a possibility that a laser power value larger than them is optimum.

In the above-described laser power adjustment method, weighting is performed so that the influence of the forward slope value becomes large, but for this reason, in the process of increasing the laser power, there is a tendency to select a laser power value present in a period from when ionization starts to occur until when the signal intensity becomes a steady state. In general, a rise in signal intensity with an increase in laser power often occurs behind the increase in SN ratio. When the signal intensity is not greater than a certain level, since the amount of generated ions is not sufficient, the processing in steps S3 and S4 is easily affected by deterioration of the ion detector or deterioration of the laser light source, and there is a high possibility that the signal intensity is determined not to satisfy the reference value for all the plot points even though the use period of the device is short. The occurrence of such a situation leads to an increase in human cost and a decrease in measurement efficiency.

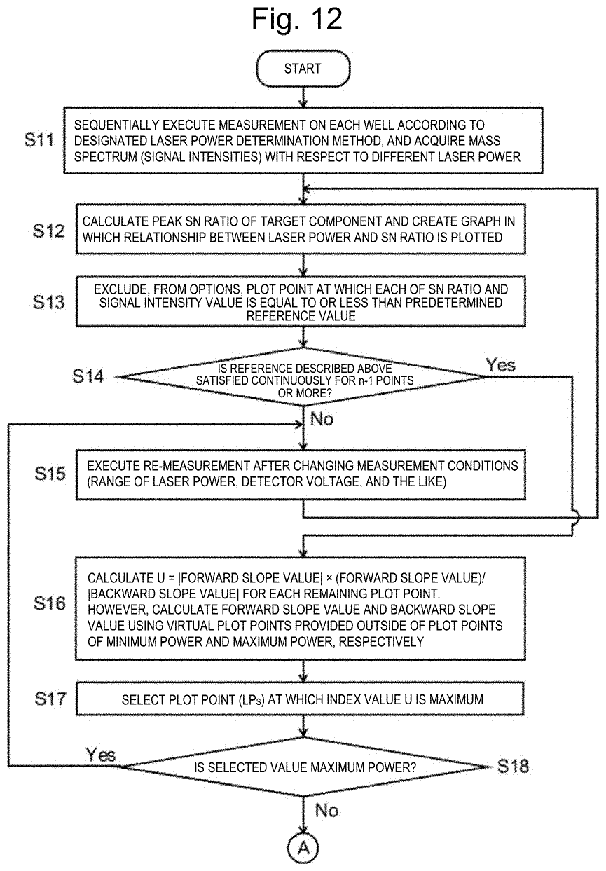

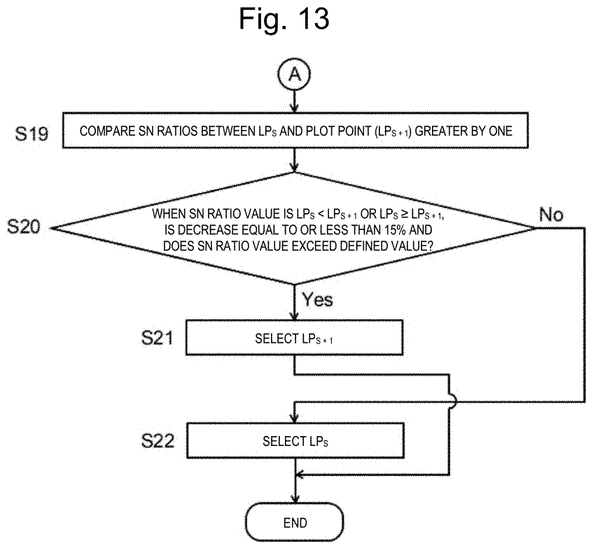

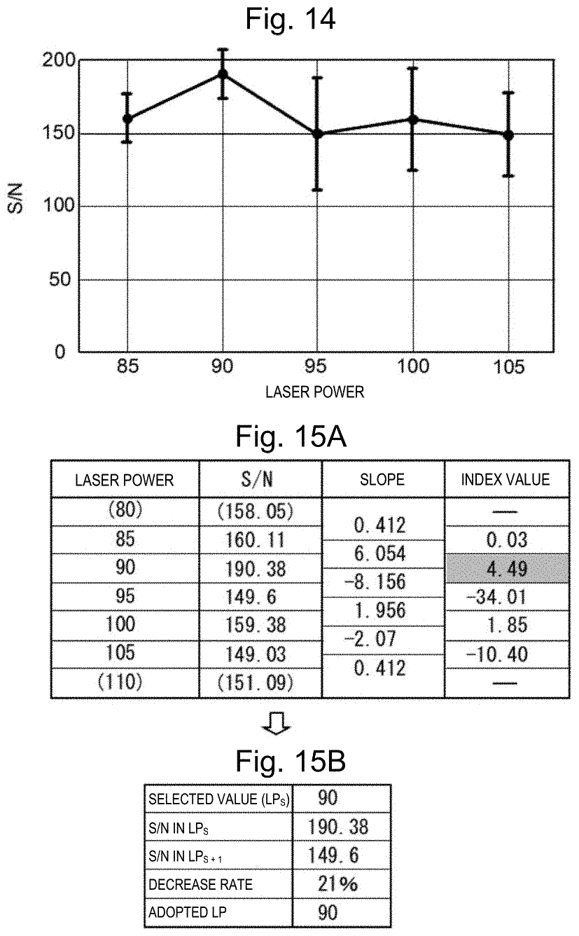

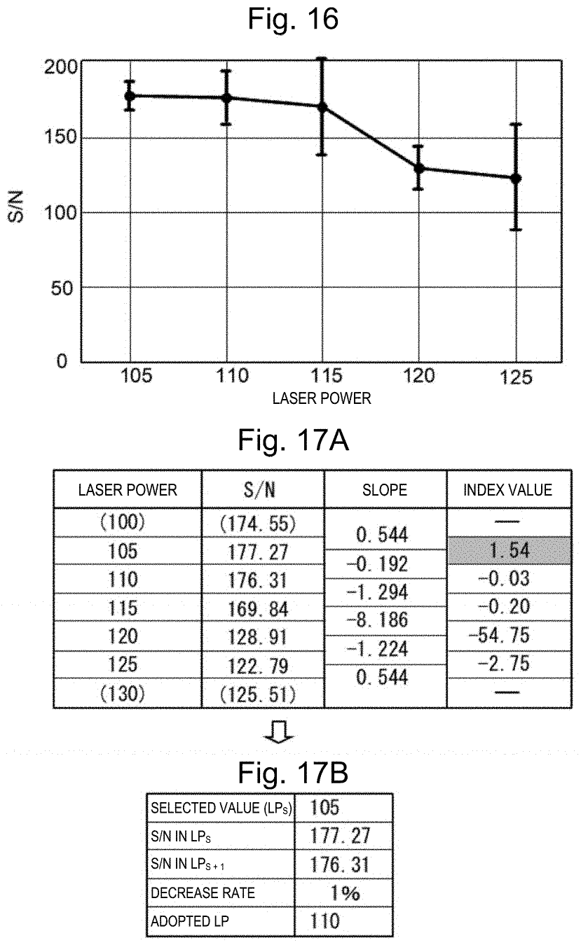

FIGS. 12 and 13 are flowcharts of an improved example of the laser power adjustment method in order to mainly overcome the above-described points. With reference to FIGS. 12 and 13, the procedure of the laser power adjustment method, which is this improved example, will be described.

In FIG. 12, steps S11 to S13 are the same as steps S1 to S3 of the flowchart shown in FIG. 2, and thus description will be omitted.

After exclusion processing of plot points in step S13, the optimum laser power search unit 212 determines whether or not the plot points satisfy the reference value continuously for n−1 points or more (step S14). As described above, n is the number of stages for changing the laser power. If it is determined No in step S14, the process proceeds to step S15 similar to step S8, and the laser power determination control unit 24 changes the measurement condition defined in the designated laser power determination method, and then controls the measurement unit 1 so as to execute re-measurement on the sample. On the other hand, if it is determined Yes in step S14, the optimum laser power search unit 212 executes the processing of step S16, which is the same as step S6.

That is, the optimum laser power search unit 212 calculates the index value U using the following formula (1) presented again for each plot point remaining after step S13 (step S16).

U=|Forward slope value|×(Forward slope value)/|Backward slope value| (1)

The optimum laser power search unit 212 selects, as an optimum laser power value candidate LPs, the laser power of the plot point at which the index value U is maximized (step S17).

Next, the optimum laser power search unit 212 determines whether or not the selected optimum laser power value candidate LP_{S} is the maximum power among the n stages of laser power at that time point (step S18). If it is the maximum power, the process proceeds to step S15 described above, and re-measurement is performed.

On the other hand, if the optimum laser power value candidate LP_{S} is not the maximum power among the n stages of laser power at that time point, it is determined whether or not to adopt a higher laser power value. Therefore, the optimum laser power search unit 212 compares the SN ratio value in the optimum laser power value candidate LP_{S} with the SN ratio value in the laser power LP_{S+1}, which is larger by one step than it (step S19). Then, it is determined whether or not the SN ratio value is LP_{S}<LP_{S+1} and, if the SN ratio value is LP_{S}≥LP_{S+1}, whether or not the decrease of the SN ratio is a decrease by 15% or less and the SN ratio exceeds a predetermined defined value (step S20).

If Yes in step S20, the optimum laser power search unit 212 selects, as the optimum laser power, the laser power value LP_{S+1} having the larger laser power (step S21). On the other hand, if No in step S20, the optimum laser power search unit 212 selects, as the optimum laser power, the laser power value LP_{S} having the smaller laser power (step S22).

By providing the processing of step S14 instead of the processing of steps S4 and S5 in the laser power adjustment method described above, even in a case where the noise increases when the laser power increases and the SN ratio does not satisfy the reference value, it becomes possible to determine an appropriate SN ratio in a region where the laser power is smaller than that. It is possible to prevent erroneous determination due to an accidental measurement result by setting continuous satisfaction of the reference value by a predetermined number (n−1 in the above example) as a precondition of determination using the index value.

In this laser power adjustment method, by adding the determination processing of step S18, it is possible to avoid a situation in which the optimum value of the laser power cannot be selected due to an inappropriate variable range of the laser power at the time of analysis or the like.

In this laser power adjustment method, by the processing of steps S19 to S22, the laser power larger than the laser power value at which the SN ratio is maximized tends to be selected as the optimum value. This is because of the following reason. As described above, in general, the laser power at which the signal intensity value is maximized tends to be larger than the laser power value at which the SN ratio is maximized. When the signal intensity value is low, the signal intensity value is easily affected by deterioration of an ionization laser light source, variation in light intensity, deterioration of an ion detector, or the like, and variation in signal intensity value easily occurs. Therefore, as long as the decrease in the SN ratio is acceptable, it can be deemed to be advantageous to set the laser power so as to obtain a high signal intensity in order to satisfactorily perform qualitative analysis and quantitative analysis over a long period of time.

Note that in the above-described embodiment, the weighting method that weighs the forward slope value more heavily than the backward slope value is not limited to the above-described method, and other appropriate methods can be adopted.

In the above embodiment, when the measurement is performed while changing the laser power, the laser power is changed at equal intervals, but it is not necessarily. However, in the case of not equal intervals, it is to be noted that it is necessary to perform calculation reflecting the difference in intervals of the laser power when calculating the slope of the straight line between the adjacent plot points.

In the above embodiment, the present invention is applied to an MALDI-TOFMS, but the present invention is not limited to a MALDI ion source, and can be applied to a mass spectrometer equipped with various ion sources that irradiate a specimen with laser light to ionize components in the specimen, such as the LDI method and the SALDI method. At that time, the type and method of the mass separator are not limited.

[Various Modes]

It will be understood by those skilled in the art that the exemplary embodiment described above is a specific example of the following modes.

(Clause 1)

One mode of a laser desorption/ionization mass spectrometer according to the present invention includes:

an ion source configured to ionize a component in a specimen by irradiating the specimen with laser light;

a mass spectrometry unit configured to perform mass spectrometry of ions generated by the ion source;

an analysis control unit configured to control each of the ion source and the mass spectrometry unit so as to acquire intensity information on ions derived from a specific component in a specimen while changing laser power of the laser light in n stages (n is 3 or more) for an identical specimen; and

a processing unit configured to: calculate a slope of a straight line connecting two adjacent plot points on a laser power axis in a two-axis graph in which a relationship between n ionic intensities obtained under control of the analysis control unit or a signal value, which is an SN ratio obtained from the ionic intensities, and laser power is plotted; obtain, for each plot point, an index value reflecting a ratio between a forward slope value, which is a slope of a straight line on a front side of the plot point, and a backward slope value, which is a slope of a straight line on a rear side; and select an appropriate laser power using the index value.

(Clause 13)

One mode of a laser power adjustment method according to the present invention is a laser power adjustment method for ionization in a laser desorption/ionization mass spectrometer, the adjustment method including:

a measurement step in which intensity information on ions derived from a specific component in a specimen are acquired while changing laser power in n stages (n is 3 or more) for an identical specimen; and

a processing step in which: a slope of a straight line connecting two adjacent plot points on a laser power axis is calculated in a two-axis graph in which a relationship between n ionic intensities obtained by the measurement step or a signal value, which is an SN ratio obtained from the ionic intensities, and laser power is plotted; an index value reflecting a ratio between a forward slope value, which is a slope of a straight line on a front side of the plot point, and a backward slope value, which is a slope of a straight line on a rear side, is obtained for each plot point; and appropriate laser power is selected using the index value.

According to the laser desorption/ionization mass spectrometer according to Clause 1 and the laser power adjustment method according to Clause 13, on the basis of an actual analysis result for a specimen, appropriate laser power capable of performing highly sensitive or highly accurate analysis is determined by an objective standard without relying on judgement by an operator or the like. Due to this, the laser power to be set does not vary depending on the operator, and a reliable and good mass spectrum can be acquired. Since laser power can be determined substantially without manual intervention, human cost can be reduced, analysis efficiency can be improved, and it is also advantageous for automation of analysis. Furthermore, since the procedure for determining appropriate laser power is close to that based on a general human judgment criterion, there is also an advantage that the operator may not feel strange about the determined laser power value.

(Clause 2)

In the laser desorption/ionization mass spectrometer according to Clause 1, the processing unit may be configured to perform comparison and determination processing of comparing a signal value at laser power selected on a basis of the index value with a signal value at laser power one stage greater than the laser power, and selecting any one of the two laser powers as appropriate laser power by using the comparison result.

(Clause 14)

Similarly, in the laser power adjustment method according to Clause 13, the processing step may include a comparison and determination step of comparing a signal value at laser power selected on a basis of the index value with a signal value at laser power one stage greater than the laser power, and selecting any one of the two laser powers as appropriate laser power by using the comparison result.

(Clause 3)

In the laser desorption/ionization mass spectrometer according to Clause 2, the processing unit may be configured to, in the comparison and determination processing, compare an SN ratio at laser power selected on a basis of the index value with an SN ratio at laser power one stage greater than the laser power, and, in a case where the latter SN ratio is larger than the former SN ratio, or is smaller than the former SN ratio with a decrease equal to or less than a predetermined value and the latter SN ratio exceeds a predetermined defined value, select the laser power one stage greater as appropriate laser power.

(Clause 15)

Similarly, in the laser power adjustment method according to Clause 14, in the comparison and determination step, an SN ratio at laser power selected on a basis of the index value may be compared with an SN ratio at laser power one stage greater than the laser power, and, in a case where the latter SN ratio is larger than the former SN ratio, or is smaller than the former SN ratio with a decrease equal to or less than a predetermined value and the latter SN ratio exceeds a predetermined defined value, the laser power one stage greater may be selected as appropriate laser power.

According to the laser desorption/ionization mass spectrometers according to Clause 2 and Clause 3 and the laser power adjustment methods according to Clause 14 and Clause 15, even in a case where the SN ratio is greatly decreased unexpectedly in the process of increasing the laser power, for example, a more appropriate laser power value can be selected.

(Clause 4)

In the laser desorption/ionization mass spectrometer according to any one clause of Clause 1 to Clause 3, the processing unit may be configured to perform weighting in which a forward slope value is weighed more heavily than backward slope value when obtaining the index value.

(Clause 16)

Similarly, in the laser power adjustment method according to any one clause of Clause 13 to Clause 15, in the processing step, weighting in which a forward slope value is weighed more heavily than a backward slope value may be performed when the index value is obtained.

According to the device according to Clause 4 and the method according to Clause 16, it is possible to prevent the laser power in a state where the backward slope value is close to 0 from being erroneously selected, and it is effective for selecting more appropriate laser power.

(Clause 5)

In the laser desorption/ionization mass spectrometer according to any one clause of Clause 1 to Clause 4, the processing unit may be configured to: calculate, using a difference between a maximum signal value and a minimum signal value among signal values of n plot points and a degree of change in laser power, a signal value of a tentative plot point corresponding to laser power one stage lower than a laser power minimum value among the n plot points and a signal value of a tentative plot point corresponding to laser power one stage higher than a laser power maximum value among the n plot points; and obtain, using the two tentative plot points, a forward slope value of a plot point corresponding to the laser power minimum value and a backward slope value of a plot point corresponding to the laser power maximum value.

(Clause 17)

Similarly, in the laser power adjustment method according to any one of clause of Clause 13 to Clause 16, in the processing step, using a difference between a maximum signal value and a minimum signal value among signal values of n plot points and a degree of change in laser power, a signal value of a tentative plot point corresponding to laser power one stage lower than a laser power minimum value among the n plot points and a signal value of a tentative plot point corresponding to laser power one stage higher than a laser power maximum value among the n plot points may be calculated, and, using the two tentative plot points, a forward slope value of a plot point corresponding to the laser power minimum value and a backward slope value of a plot point corresponding to the laser power maximum value may be obtained.

According to the device according to Clause 5 and the method according to Clause 17, the number of stages for changing the laser power at the time of actual measurement can be reduced, and the time required for measurement can be shortened. The consumption of the sample can also be reduced.

(Clause 6)

In the laser desorption/ionization mass spectrometer according to any one clause of Clause 1 to Clause 5, the analysis control unit may be configured to control the ion source so as to change laser power in n stages at equal intervals.

(Clause 18)

Similarly, in the laser power adjustment method according to any one clause of clause 13 to clause 17, in the measurement step, laser power may be changed in n stages at equal intervals.

According to the device according to Clause 6 and the method according to Clause 18, it is possible to simplify calculation when calculating the slope of a straight line connecting two plot points.

(Clause 7)

In the laser desorption ionization mass spectrometer according to any one clause of Clause 1 to Clause 6, the processing unit may be configured to perform preprocessing of deleting a plot point at which at least any one of n ionic intensity and SN ratio is equal to or less than a predetermined reference value, and select a plot point using a forward slope value and a backward slope value for a plot point remaining after the preprocessing.

(Clause 19)

Similarly, in the laser power adjustment method according to any one clause of Clause 13 to Clause 18, in the processing step, preprocessing of deleting a plot point at which at least any one of n ionic intensities and SN ratio is equal to or less than a predetermined reference value may be performed, and a plot point using a forward slope value and a backward slope value may be selected for a plot point remaining after the preprocessing.

According to the device according to Clause 7 and the method according to Clause 19, it is possible to remove a plot point at which, for example, the SN ratio and the signal intensity are extremely low, and avoid selection of an inappropriate laser power.

(Clause 8)

In the laser desorption/ionization mass spectrometer according to any one clause of Clause 1 to Clause 7, the signal value may be an SN ratio.

(Clause 20)

Similarly, in the laser power adjustment method according to any one clause of Clause 13 to Clause 19, the signal value may be an SN ratio.

According to the device according to Clause 8 and the method according to Clause 20, since not only the signal intensity but also noise is considered, it is possible to select laser power that can obtain a good mass spectrum.

(Clause 9)

The laser desorption/ionization mass spectrometer according to any one clause of Clause 1 to Clause 8 may further include a method creation unit configured to create a measurement method including a plurality of methods for performing measurement under different laser power values having n stages, the measurement method including information on a measurement condition for the analysis control unit to control the ion source and the mass analysis unit.

In the device according to Clause 9, the method creation unit automatically creates a file of a measurement method on the basis of minimum necessary information input or set by the operator, and saves it into a predetermined storage unit. According to the device according to Clause 9, the work performed by the operator for performing measurement for appropriately adjusting the laser power is simplified, and the burden on the operator is reduced. Errors in such measurement are reduced, and the efficiency of the laser power selection work can be improved.

(Clause 10)

In the laser desorption/ionization mass spectrometer according to Clause 9, the method creation unit may be configured to receive input or selection of a reference laser power value as one of measurement conditions in a GUI screen, obtain n stages of laser power values increased and/or decreased from the reference laser power value, and create a measurement method including a plurality of methods for performing measurement under the n stages of laser power values.

According to the device according to Clause 10, since the amount of information input by the operator when creating a measurement method for laser power selection is small, work efficiency can be improved, and even an operator who is not skilled in the work can perform work without errors.

(Clause 11)

In the laser desorption/ionization mass spectrometer according to Clause 10, the method creation unit may be configured to display, in the GUI screen, a schematic image of a sample plate in which the n stages of laser power values and a position of a well provided with a measurement target specimen under the laser power values are clearly indicated.

According to the device according to Clause 11, the operator can easily confirm, on the screen, then stages of laser power values automatically set. The operator can grasp, in a visually easy-to-understand manner, the position of the well where the target specimen is to be formed.

(Clause 12)

In the laser desorption/ionization mass spectrometer according to Clause 11, a sample well provided with a target specimen and a calibrant well provided with a mass calibration specimen are arranged in the sample plate, and the method creation unit may be configured to enable setting of a laser power value different from then stages of laser power values to a specimen provided in the calibrant well.

According to the device according to Clause 11, it is possible to perform mass calibration of a measurement result for a target specimen on the basis of a result of executing measurement on a mass calibration specimen under laser power suitable for it. This makes it possible to accurately perform mass calibration of the measurement result regardless of the setting of the laser power at the time of measuring the target specimen.

### REFERENCE SIGNS LIST

### 1 . . . Measurement Unit

### 10 . . . Chamber

### 10a . . . Window

### 11 . . . Vacuum Pump

### 12 . . . Specimen Stage

### 13 . . . Sample Plate

### 14 . . . Extraction Electrode

### 15 . . . Acceleration Electrode

### 16 . . . Laser Irradiation Unit

### 17 . . . Mirror

### 18 . . . Flight Tube

### 19 . . . Ion Detector

### 100 . . . Stage Drive Unit

### 2 . . . Control/Processing Unit

### 20 . . . Data Collection Unit

### 21 . . . Laser Power Optimization Processing Unit

### 211 . . . SN Ratio Calculation Unit

### 212 . . . Optimum Laser Power Search Unit

### 213 . . . Laser Power Determination Unit

### 22 . . . Laser Power Determination Method Creation Unit

### 23 . . . Laser Power Determination Method Storage Unit

### 24 . . . Laser Power Determination Control Unit

### 3 . . . Operation Unit

### 4 . . . Display Unit

1. A laser desorption/ionization mass spectrometer comprising:
an ion source configured to ionize a component in a specimen by irradiating the specimen with laser light;
a mass spectrometry unit configured to perform mass spectrometry of ions generated by the ion source;
an analysis control unit configured: to control each of the ion source and the mass spectrometry unit so as to acquire intensity information on ions derived from a specific component in a specimen while changing laser power of the laser light in n stages (n is 3 or more) for an identical specimen; and
a processing unit configured to: calculate a slope of a straight line connecting two adjacent plot points on a laser power axis in a two-axis graph in which a relationship between n ionic intensities obtained under control of the analysis control unit or a signal value, which is an SN ratio obtained from the ionic intensities, and laser power is plotted; obtain, for each plot point, an index value reflecting a ratio between a forward slope value, which is a slope of a straight line on a front side of the plot point, and a backward slope value, which is a slope of a straight line on a rear side; and select an appropriate laser power using the index value.

2. The laser desorption/ionization mass spectrometer according to claim 1, wherein the processing unit is configured to perform comparison and determination processing of comparing a signal value at laser power selected on a basis of the index value with a signal value at laser power one stage greater than the laser power, and selecting any one of the two laser powers as appropriate laser power by using a result which is compared.

3. The laser desorption/ionization mass spectrometer according to claim 2, wherein, in the comparison and determination processing, the processing unit is configured to compare an SN ratio at laser power selected on a basis of the index value with an SN ratio at laser power one stage greater than the laser power, and, in a case where the latter SN ratio is larger than the former SN ratio, or is smaller than the former SN ratio with a decrease equal to or less than a predetermined value and the latter SN ratio exceeds a predetermined defined value, select the laser power one stage greater as appropriate laser power.

4. The laser desorption/ionization mass spectrometer according to claim 1, wherein the processing unit is configured to perform weighting in which a forward slope value is weighed more heavily than a backward slope value when obtaining the index value.

5. The laser desorption/ionization mass spectrometer according to claim 1, wherein the processing unit is configured to: calculate, using a difference between a maximum signal value and a minimum signal value among signal values of n plot points and a degree of change in laser power, a signal value of a tentative plot point corresponding to laser power one stage lower than a laser power minimum value among the n plot points and a signal value of a tentative plot point corresponding to laser power one stage higher than a laser power maximum value among the n plot points; and obtain, using the two tentative plot points, a forward slope value of a plot point corresponding to the laser power minimum value and a backward slope value of a plot point corresponding to the laser power maximum value.

6. The laser desorption/ionization mass spectrometer according to claim 1, wherein the analysis control unit is configured to control the ion source so as to change laser power in n stages at equal intervals.

7. The laser desorption/ionization mass spectrometer according to claim 1, wherein the processing unit is configured to perform preprocessing of deleting a plot point at which at least any one of n ionic intensities and an SN ratio is equal to or less than a predetermined reference value, and select a plot point using a forward slope value and a backward slope value for a plot point remaining after the preprocessing.

8. The laser desorption/ionization mass spectrometer according to claim 1, wherein the signal value is an SN ratio.

9. The laser desorption/ionization mass spectrometer according to claim 1, further comprising a method creation unit configured to create a measurement method including a plurality of methods for performing ionization under different laser power values having n stages, the measurement method including information on a measurement condition for the analysis control unit to control the ion source and the mass spectrometry unit.

10. The laser desorption/ionization mass spectrometer according to claim 9, wherein the method creation unit is configured to receive input or selection of a reference laser power value as one of measurement conditions in a GUI screen, obtain n stages of laser power values increased and/or decreased from the reference laser power value, and create a measurement method including a plurality of methods for performing ionization under the n stages of laser power values.

11. The laser desorption/ionization mass spectrometer according to claim 10, wherein the method creation unit is configured to display, in the GUI screen, a schematic image of a sample plate in which the n stages of laser power values and a position of a well provided with a measurement target specimen under the laser power values are clearly indicated.

12. The laser desorption/ionization mass spectrometer according to claim 11, wherein a sample well provided with a target specimen and a calibrant well provided with a mass calibration specimen are arranged in the sample plate, and the method creation unit is configured to enable setting of a laser power value different from the n stages of laser power values to a specimen provided in the calibrant well.

13. A laser power adjustment method for ionization in a laser desorption/ionization mass spectrometer, the laser power adjustment method comprising:
a measurement step in which intensity information on ions derived from a specific component in a specimen are acquired while changing laser power in n stages to is 3 or more) for an identical specimen; and
a processing step in which: a slope of a straight line connecting two adjacent plot points on a laser power axis is calculated in a two-axis graph in which a relationship between n ionic intensities obtained by the measurement step or a signal value, which is an SN ratio obtained from the ionic intensities, and laser power is plotted; an index value reflecting a ratio between a forward slope value, which is a slope of a straight line on a front side of the plot point, and a backward slope value, which is a slope of a straight line on a rear side, is obtained for each plot point; and appropriate laser power is selected using the index value.

14. The laser power adjustment method according to claim 13, wherein the processing step includes a comparison and determination step of comparing a signal value at laser power selected on a basis of the index value with a signal value at laser power one stage greater than the laser power, and selecting any one of the two laser powers as appropriate laser power by using a result which is compared.

15. The laser power adjustment method according to claim 14, wherein in the comparison and determination step, an SN ratio at laser power selected on a basis of the index value is compared with an SN ratio at laser power one stage greater than the laser power, and, in a case where the latter SN ratio is larger than the former SN ratio, or is smaller than the former SN ratio with a decrease equal to or less than a predetermined value and the latter SN ratio exceeds a predetermined defined value, the laser power one stage greater is selected as appropriate laser power.

16. The laser power adjustment method according to claim 13, wherein, in the processing step, weighting in which a forward slope value is weighed more heavily than a backward slope value is performed when the index value is obtained.

17. The laser power adjustment method according to claim 13, wherein, in the processing step, using a difference between a maximum signal value and a minimum signal value among signal values of n plot points and a degree of change in laser power, a signal value of a tentative plot point corresponding to laser power one stage lower than a laser power minimum value among the n plot points and a signal value of a tentative plot point corresponding to laser power one stage higher than a laser power maximum value among the n plot points are calculated, and, using the two tentative plot points, a forward slope value of a plot point corresponding to the laser power minimum value and a backward slope value of a plot point corresponding to the laser power maximum value are obtained.

18. The laser power adjustment method according to claim 13, wherein in the measurement step, laser power is changed in n stages at equal intervals.

19. The laser power adjustment method according to claim 13, wherein in the processing step, preprocessing of deleting a plot point at which at least any one of n ionic intensities and an SN ratio is equal to or less than a predetermined reference value is performed, and a plot point using a forward slope value and a backward slope value is selected for a plot point remaining after the preprocessing.

20. The laser power adjustment method according to claim 13, wherein the signal value is an SN ratio.
